(19) United States
(12) Patent Application Publication
(10) Pub. No.: US 2019/0061418 A1
(43) Pub. Date: Feb. 28, 2019

(54) DISPOSABLE PAINT CAN RIM PROTECTOR WITH CIRCUMFERENTIAL SEALING RIDGE

(71) Applicant: Stephen A. Easterling, Clarkdale, AZ (US)

(72) Inventor: Stephen A. Easterling, Clarkdale, AZ (US)

(21) Appl. No.: 15/686,535

(22) Filed: Aug. 25, 2017

(51) Int. Cl. B44D 3/12

(52) U.S. Cl. CPC B44D 3/128

(57) ABSTRACT

A disposable paint can rim protector is disclosed for protecting the rim of a paint can while painting to make cleanup easier and preserve leftover paint. The rim protector is for paint cans having a circumferential groove for receiving a circumferential sealing ridge of a paint can lid. The rim protector prevents paint from collecting in the circumferential groove, ensuring a clean seal with the lid sealing ridge. The rim protector includes a circular flat ring having an inner diameter and an outer diameter, a circumferential sealing ridge protruding from the circular flat ring and extending all around the circular flat ring, and a pull-tab extending from the circular flat ring. The circumferential sealing ridge has a cross-section configured to be snugly insertable into the circumferential groove of the rim of the paint can. The circular flat ring, the circumferential sealing ridge, and the pull-tab, are all of one piece.

### FIELD OF THE INVENTION

This invention relates generally to paint cans, and particularly to devices for protecting the rim of a paint can during painting so as to facilitate re-sealing of the paint can after painting.

### BACKGROUND OF THE INVENTION

Paint is typically stored in a can that comes sealed with a lid that can be pried open and removed to allow use the paint in the can. To seal the can, the lid includes a circumferential ridge that can be snugly seated in a circumferential groove in the rim of the can. To open the can, the lid must be pried upward so as to disengage the circumferential ridge of the lid from the circumferential groove of the rim of the can.

When paint in the can is used, substantial portions of the rim of the can typically become covered or filled with paint. The paint tends to flow into the circumferential rim of the can, and after some time, dries and becomes hard. In many cases, this can happen a few times, adding layers of dried paint to the rim of the can and into the circumferential groove.

Usually, only a portion of the paint in a can is consumed during a painting session, and the can must be re-sealed with the lid so as to prevent the paint in the can from drying out before its next use. However, the dried paint lodged in the circumferential groove of the rim of the can blocks the circumferential ridge of the lid from engaging with the circumferential grove. An ineffective seal results, causing the remainder of the paint in the can to be exposed to air, thereby resulting in undesirable drying of the remaining paint, which eventually renders the remaining paint unusable.

Others have attempted to solve this problem. For example, in U.S. Pat. No. 5,172,822 teaches a device which extends from the inside to the outside surfaces of the rim of a paint can, having an inward-sloping top section to direct excess paint into the can, and a curled outer lip to catch excess paint that might otherwise drip down the side of the can. In fact, latex paint dries so quickly that any job that takes more than ten minutes would result in encrusted dried paint on the device, making it harder to reuse unless it is cleaned after each use.

Another example is U.S. Pat. No. 6,702,144, this device also being attached to the outer surfaces of rim of the can, and further using magnets to assist in holding the device in place so as to protect the rim of the can. It also has an inward-sloping top section to direct excess paint into the can.

Yet another example is U.S. Pat. No. 6,253,951 this device being an adhesive-coated flat ring that can adhere to the topmost surface of the rim of a can, thereby preventing the groove of the rim from accumulating dried paint. A paper cover protects the adhesive coating of the flat ring until it is ready for use.

### SUMMARY

A disposable paint can rim protector has a circular flat ring with a circumferential sealing ridge configured to be snugly insertable into a circumferential groove of the rim of a paint can.

The paint can rim protector can also have a removal tab attached to the circular flat ring to help extract the circumferential sealing ridge from a circumferential groove of a paint can.

The paint can rim protector prevents paint from clogging the circumferential groove of a paint can while using the paint can for a painting project. The paint can rim protector aids in clean-up, and helps to preserve unused paint.

The paint can rim protector is disposable, and therefore it does not need to be cleaned. Instead, a user can inexpensively purchase a bag of 50 rim protectors, for example, and use a new one for each project.

The paint can rim protector can have a circumferential sealing ridge shaped much like the circumferential sealing ridge of a paint can lid, and so it fits snugly into the circumferential groove of the rim of a paint can.

While the circumferential sealing ridge of the paint can rim protector is snugly engaged with the circumferential groove of the rim of the paint can, the circumferential groove of the rim of the paint can is completely protected from contact with any paint, even if the outer side of the paint can rim protector is covered with paint. Thus, when the paint can rim protector is removed, a clean circumferential groove of the rim of the paint can is revealed, which is then free to receive the circumferential sealing ridge of the paint can lid, thereby forming an airtight seal that prevents the paint remaining in the can from drying out.

A general aspect of the invention is a paint can rim protector for protecting the rim of a paint can, the rim having a circumferential groove for receiving a circumferential sealing ridge of a paint can lid. This rim protector includes: a circular flat ring having an inner diameter and an outer diameter; and a circumferential sealing ridge protruding from the circular flat ring along at least a portion of the circular flat ring, the circumferential sealing ridge having a cross-section along the portion configured to be snugly insertable into the circumferential groove of the rim of a paint can.

In some embodiments, the paint can rim protector further incudes a pull-tab extending from the circular flat ring.

In some embodiments, the circular flat ring and the circumferential sealing ridge are each made from a material that is disposable.

In some embodiments, the circular flat ring and the circumferential sealing ridge are each made from one of: rubber, silicone, flexible plastic.

In some embodiments, the circumferential sealing ridge is configured so as to be shaped substantially like a circumferential sealing ridge of a paint can lid.

In some embodiments, the circumferential sealing ridge extends around the entire circular flat ring.

In some embodiments, the circular flat ring and the circumferential sealing ridge are all of one piece.

In some embodiments, the inner diameter and the outer diameter of the circular flat ring are sized such that the circular flat ring can cover the entire rim of a commercially available paint can.

In some embodiments, the circumferential sealing ridge has an inner diameter that is greater than the inner diameter of the circular flat ring, and the circumferential sealing ridge has an outer diameter that is less than the outer diameter of the circular flat ring.

Another general aspect of the invention is a paint can rim protector for protecting the rim of a paint can, the rim having a circumferential groove for receiving a circumferential sealing ridge of a paint can lid, the rim protector including: a circular flat ring having an inner diameter and an outer diameter; a circumferential sealing ridge protruding from the circular flat ring and extending all around the circular flat ring, the circumferential sealing ridge having a cross-section configured to be snugly insertable into the circumferential groove of the rim of a paint can; and a pull-tab extending from the circular flat ring, the circular flat ring, the circumferential sealing ridge, and the pull-tab all being of one piece.

In some embodiments, the circular flat ring and the circumferential sealing ridge are each made from a material that is disposable.

In some embodiments, the circular flat ring and the circumferential sealing ridge are each made from one of: rubber, silicone, flexible plastic.

In some embodiments, the circumferential sealing ridge is configured so as to be shaped substantially like a circumferential sealing ridge of a paint can lid.

In some embodiments, the inner diameter and the outer diameter of the circular flat ring are sized such that the circular flat ring can cover the entire rim of a commercially available paint can.

In some embodiments, the circumferential sealing ridge has an inner diameter that is greater than the inner diameter of the circular flat ring, and the circumferential sealing ridge has an outer diameter that is less than the outer diameter of the circular flat ring.

Another general aspect of the invention is a paint can rim protector for protecting the rim of a paint can, the rim having a circumferential groove for receiving a circumferential sealing ridge of a paint can lid, this rim protector including: a circular flat ring having an inner diameter and an outer diameter; a circumferential sealing ridge protruding from the circular flat ring and extending all around the circular flat ring, the circumferential sealing ridge having a cross-section configured to be snugly insertable into the circumferential groove of the rim of a paint can; and a pull-tab extending from the circular flat ring, the circular flat ring, the circumferential sealing ridge, and the pull-tab all being of one piece.

In some embodiments, the circumferential sealing ridge is configured to protrude into the circumferential groove of the rim of a paint can such that circumferential sealing ridge can make contact with a bottom portion of the circumferential groove of the rim of a paint can.

In some embodiments, the circumferential sealing ridge is configured to protrude into the circumferential groove of the rim of a paint can such that circumferential sealing ridge can make contact with both inner sides of the circumferential groove of the rim of a paint can.

In some embodiments, the circumferential sealing ridge is configured so as to be shaped substantially like a circumferential sealing ridge of a paint can lid.

In some embodiments, the inner diameter and the outer diameter of the circular flat ring are sized such that the circular flat ring can cover the entire rim of a commercially available paint can.

### BRIEF DESCRIPTION OF THE DRAWINGS

The invention will be more fully understood from the following Detailed Description, in conjunction with the following figures, wherein:

FIG. 1 is an isometric bottom view of an embodiment of the paint can rim protector for protecting the rim of a paint can, the rim having a circumferential groove for receiving a circumferential sealing ridge of a paint can lid.

FIG. 2 is a top view of the paint can rim protector of FIG. 1.

FIG. 3 is a bottom view of the paint can rim protector of FIG. 1.

FIG. 4 is a cross-sectional side view of the paint can rim protector of FIG. 1.

FIG. 5 is an isometric top view of the paint can rim protector of FIG. 1, the paint can rim protector shown above the rim of a paint can.

FIG. 6 is an isometric top view of the pain can rim protector of FIG. 5 in use, where the circumferential sealing ridge of the paint can rim protector of FIG. 5 is seated in the circumferential groove of the rim of the paint can.

FIG. 7 is a cross-sectional side view of the rim of the can of FIG. 6, showing the circumferential sealing ridge of the paint can rim protector of FIG. 6 seated in the circumferential groove of the rim of the paint can, thereby preventing the circumferential groove of the rim of the paint can from becoming clogged with paint.

### DETAILED DESCRIPTION

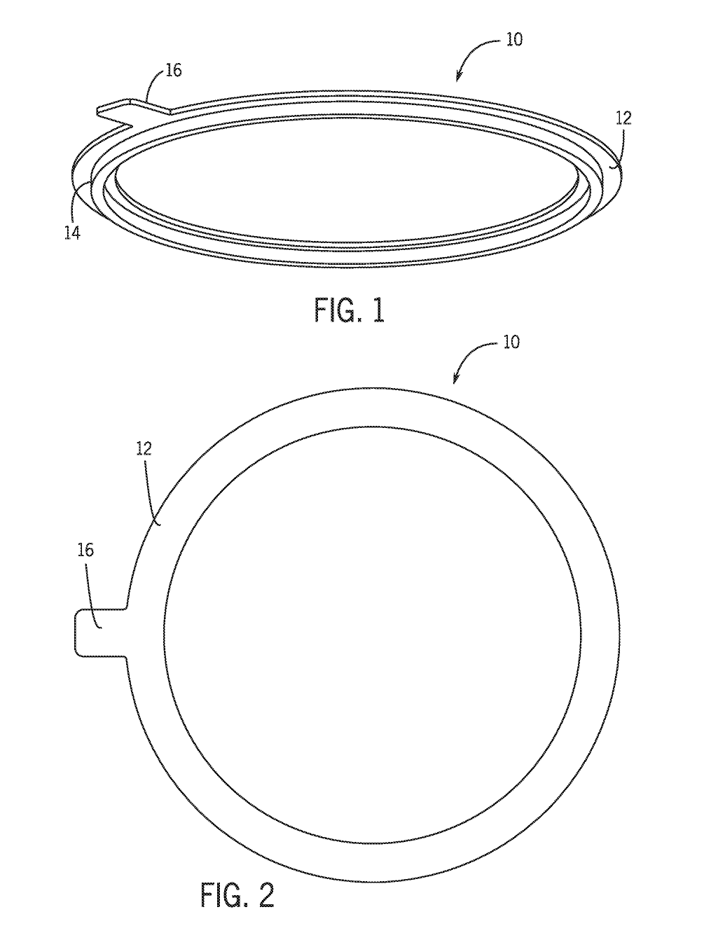

With reference to FIG. 1, an embodiment of the paint can rim protector 10 is shown. The rim protector 10 has a circular flat ring 12 with a circumferential sealing ridge 14 that protrudes perpendicularly from the circular flat ring 12. The circumferential sealing ridge 14 has a cross-section along its length sized and shaped so that it can be snugly inserted into the circumferential groove around the rim of a paint can that is formed so as to receive the circumferential sealing ridge of a paint can lid. In some embodiments, the circumferential sealing ridge 14 has a cross-section along its length sized and shaped like the circumferential sealing ridge of a paint can lid. In preferred embodiments, the circumferential sealing ridge 14 and the circular flat ring 12 are integral parts of the same piece.

To use the rim protector 10 to protect the rim of a paint can, the paint can is first opened by removing the lid of the paint can. Before painting begins, the circumferential sealing ridge 14 of the rim protector 10 is inserted into the circumferential groove around the rim of the paint can, thereby preventing paint from collecting in the circumferential groove of the rim of the paint can. Also, the circular flat ring 12 of the rim protector 10 effectively covers the surrounding top surface of the rim of the paint can.

Then, when ready to clean up after a painting session, the rim protector 10 can be removed from the rim of the paint can by pulling on the tab 16 that extends from the circular flat ring 12 of the rim protector 10 until the circumferential sealing ridge 14 of the rim protector 10 pulls out of the circumferential groove around the rim of the paint can, revealing a clean circumferential groove and a clean top portion of the rim of the paint can. Consequently, the circumferential sealing ridge of the paint can lid can form an air-tight seal when the paint can lid is again used to seal the can, thereby preserving the paint remaining in the can.

The rim protector 10 can be made from rubber, or silicone, or flexible plastic, for example. Consequently, after the rim protector 10 is removed from the rim of the paint can by pulling on the tab 16, the rim protector 10 can be discarded.

Referring to FIG. 2, a top view of the rim protector 10 is shown, where the circular flat ring 12 has a width that is sized so as to cover the rim of a paint can. For example, the ring 12 can have an inner diameter of about 5.5 inches, and can have an outer diameter of about 6.5 inches. In preferred embodiments, the tab 16 and the circular flat ring 12 are integral parts of the same piece.

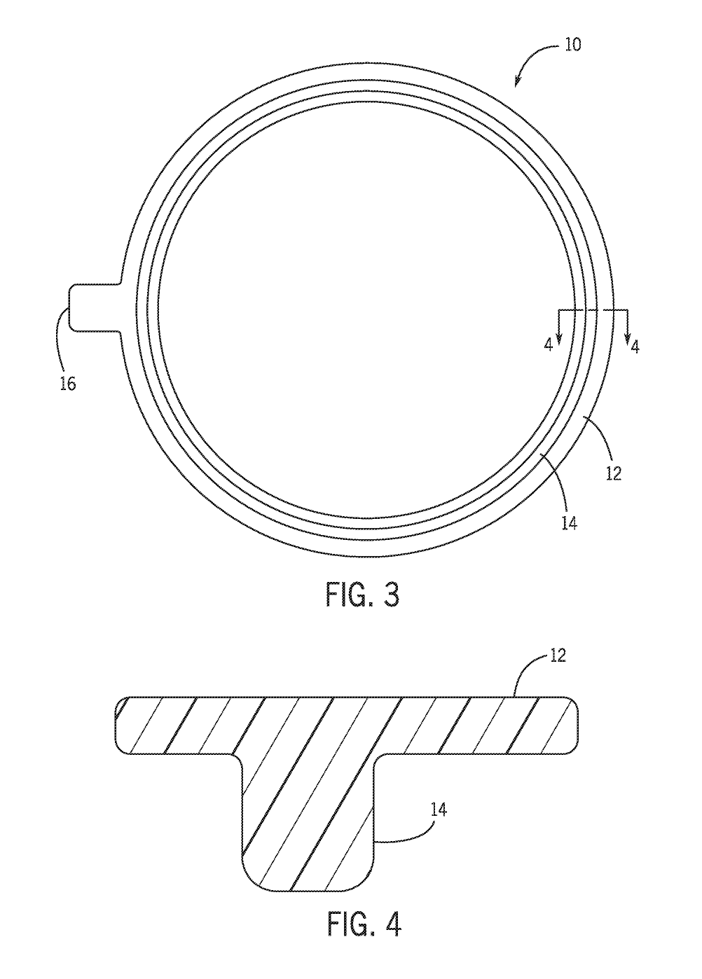

Referring to FIG. 3, a bottom view of the rim protector 10 shows the circular flat ring 12 with the circumferential sealing ridge 14 that protrudes perpendicularly from the circular flat ring 12. For example, the ring 12 can have an inner diameter of about 5.5 inches, and can have an outer diameter of about 6.5 inches, and the circumferential sealing ridge 14 can have an inner diameter of about 5.678 inches, and can have an outer diameter of about 6.027 inches.

Referring to FIG. 4, a cross-sectional side view shows an embodiment of the rim protector 10 where the circular flat ring 12 and the circumferential sealing ridge 14 are integral parts of the same piece.

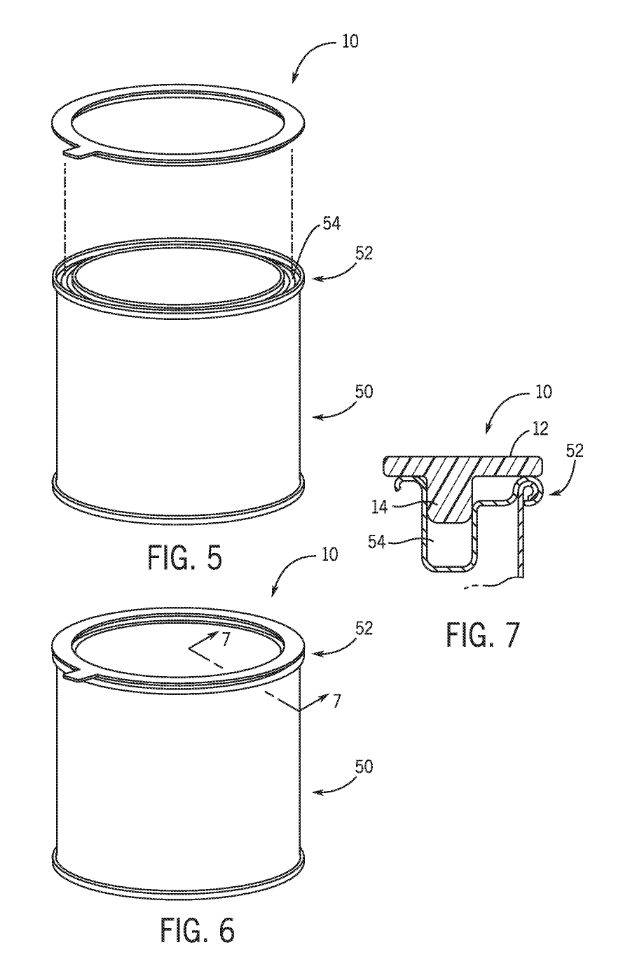

Referring to FIG. 5, an orthographic top view is shown of the rim protector 10 located over a paint can 50 having a rim 52 that includes a circumferential groove 54.

Referring to FIG. 6, an orthographic top view is shown of the rim protector 10 and the paint can 50, where the circumferential sealing ridge 14 (not shown) of the paint can rim protector 10 is seated in the circumferential groove 54 (not shown) of the rim 52 of the paint can 50.

Referring to FIG. 7, a cross-sectional side view of the circumferential groove 54 of the rim 52 of the paint can 50 is shown, also showing the circumferential sealing ridge 14 perpendicularly extending from the circular flat ring 12 of the paint can rim protector 10, circumferential sealing ridge 14 being seated within and along the entire circumference of the circumferential groove 54 of the rim 52 of the paint can 50.

Other modifications and implementations will occur to those skilled in the art without departing from the spirit and the scope of the invention as claimed. Accordingly, the above description is not intended to limit the invention, except as indicated in the following claims.

What is claimed is:

1. A paint can rim protector for protecting the rim of a paint can, the rim having a circumferential groove for receiving a circumferential sealing ridge of a paint can lid, the paint can rim protector comprising:
a circular flat ring having an inner diameter and an outer diameter; and
a circumferential sealing ridge protruding from the circular flat ring along at least a portion of the circular flat ring, the circumferential sealing ridge having a cross-section along the portion configured to be snugly insertable into the circumferential groove of the rim of a paint can.

2. The paint can rim protector of claim 1, further comprising:
a pull-tab extending from the circular flat ring.

3. The paint can rim protector of claim 1, wherein the circular flat ring and the circumferential sealing ridge are each made from a material that is disposable.

4. The paint can rim protector of claim 1, wherein the circular flat ring and the circumferential sealing ridge are each made from one of: rubber, silicone, flexible plastic.

5. The paint can rim protector of claim 1, wherein the circumferential sealing ridge is configured so as to be shaped substantially like a circumferential sealing ridge of a paint can lid.

6. The paint can rim protector of claim 1, wherein the circumferential sealing ridge extends around the entire circular flat ring.

7. The paint can rim protector of claim 1, wherein the circular flat ring and the circumferential sealing ridge protruding from the circular flat ring are all of one piece.

8. The paint can rim protector of claim 1, wherein the inner diameter and the outer diameter of the circular flat ring are sized such that the circular flat ring can cover the entire rim of a commercially available paint can.

9. The paint can rim protector of claim 1, wherein the circumferential sealing ridge has an inner diameter that is greater than the inner diameter of the circular flat ring, and
the circumferential sealing ridge has an outer diameter that is less than the outer diameter of the circular flat ring.

10. A paint can rim protector for protecting the rim of a paint can, the rim having a circumferential groove for receiving a circumferential sealing ridge of a paint can lid, the paint can rim protector comprising:
a circular flat ring having an inner diameter and an outer diameter;
a circumferential sealing ridge protruding from the circular flat ring and extending all around the circular flat ring, the circumferential sealing ridge having a cross-section configured to be snugly insertable into the circumferential groove of the rim of a paint can; and
a pull-tab extending from the circular flat ring,
the circular flat ring, the circumferential sealing ridge, and the pull-tab all being of one piece.

11. The paint can rim protector of claim 10, wherein the circular flat ring and the circumferential sealing ridge are each made from a material that is disposable.

12. The paint can rim protector of claim 10, wherein the circular flat ring and the circumferential sealing ridge are each made from one of: rubber, silicone, flexible plastic.

13. The paint can rim protector of claim 10, wherein the circumferential sealing ridge is configured so as to be shaped substantially like a circumferential sealing ridge of a paint can lid.

14. The paint can rim protector of claim 10, wherein the inner diameter and the outer diameter of the circular flat ring are sized such that the circular flat ring can cover the entire rim of a commercially available paint can.

15. The paint can rim protector of claim 10, wherein the circumferential sealing ridge has an inner diameter that is greater than the inner diameter of the circular flat ring, and
the circumferential sealing ridge has an outer diameter that is less than the outer diameter of the circular flat ring.

16. A paint can rim protector for protecting the rim of a paint can, the rim having a circumferential groove for receiving a circumferential sealing ridge of a paint can lid, the paint can rim protector comprising:
a circular flat ring having an inner diameter and an outer diameter;
a circumferential sealing ridge protruding from the circular flat ring and extending all around the circular flat ring, the circumferential sealing ridge having a cross-section configured to be snugly insertable into the circumferential groove of the rim of a paint can; and
a pull-tab extending from the circular flat ring,
the circular flat ring, the circumferential sealing ridge, and the pull-tab all being of one piece.

17. The paint can rim protector of claim 16, wherein the circumferential sealing ridge is configured to protrude into the circumferential groove of the rim of a paint can such that circumferential sealing ridge can make contact with a bottom portion of the circumferential groove of the rim of a paint can.

18. The paint can rim protector of claim 16, wherein the circumferential sealing ridge is configured to protrude into the circumferential groove of the rim of a paint can such that circumferential sealing ridge can make contact with both inner sides of the circumferential groove of the rim of a paint can.

19. The paint can rim protector of claim 16, wherein the circumferential sealing ridge is configured so as to be shaped substantially like a circumferential sealing ridge of a paint can lid.

20. The paint can rim protector of claim 16, wherein the inner diameter and the outer diameter of the circular flat ring are sized such that the circular flat ring can cover the entire rim of a commercially available paint can.
